(19) United States
(12) Patent Application Publication
(10) Pub. No.: US 2020/0051566 A1
(43) Pub. Date: Feb. 13, 2020

(54) ARTIFICIAL INTELLIGENCE DEVICE FOR PROVIDING NOTIFICATION TO USER USING AUDIO DATA AND METHOD FOR THE SAME

(71) Applicant: LG ELECTRONICS INC., Seoul (KR)

(72) Inventor: Seungyoon SHIN, Seoul (KR)

(73) Assignee: LG ELECTRONICS INC., Seoul (KR)

(21) Appl. No.: 16/598,863

(22) Filed: Oct. 10, 2019

(30) Foreign Application Priority Data
Aug. 28, 2019 (KR) 10-2019-0105999

(51) Int. Cl. G10L 15/22; G06F 3/16; H04R 3/00; G10L 15/30

(52) U.S. Cl. CPC G10L 15/22; G06F 3/167; G10L 2015/088; G10L 15/30; G10L 2015/223; H04R 3/005

(57) ABSTRACT

The present disclosure provides an artificial intelligence device for providing notification to a user using audio data, the artificial intelligence device including: a memory configured to store a trigger sound that should be notified to a user and information about notification corresponding to the trigger sound; a microphone configured to receive audio data; a processor configured to change a volume gain of the microphone on the basis of a noise level of the audio data received from the microphone, to determine whether the audio data received from the microphone correspond to a trigger sound that should be notified to the user, and to extract notification corresponding to the determined trigger sound; and an output unit configured to output the extracted notification.

### CROSS-REFERENCE TO RELATED APPLICATION

This application claims the benefit of Korean Patent Application No. 10-2019-0105999, filed on Aug. 28, 2019 which is hereby incorporated by reference as if fully set forth herein.

### BACKGROUND OF THE INVENTION

### Field of the Invention

The present disclosure relates to an artificial intelligence device for providing notification to a user using audio data.

### Description of the Related Art

Artificial intelligence, which is a field of computer engineering and information technology that study a method of enabling a computer to perform thinking, learning, and self-development that can be achieved by human intelligence, means a technology that enables a computer to follow intelligent behaviors of human.

Further, artificial intelligence does not exist by itself, but is in directly and indirectly associated a lot with other fields of computer science. In particular, it is recently actively attempted to introduce artificial intelligent factors into various fields of an information technology and use the factors to solve problems in the fields.

Meanwhile, a technology that recognizes and learns surrounding situations using artificial intelligence and provides information, which a user wants, in a desired type or performs operations or functions that a user wants has been actively studied.

Further, an electronic device that provides these various operations and functions may be referred to as an artificial intelligence device.

Meanwhile, a user who is listening music through a headset or an earphone has difficulty in hearing sounds generated outside and recognizing external situations.

Accordingly, there is a problem in that an accident occurs because a user listening music cannot hear the sound of an approaching vehicle.

Accordingly, there is an increasing need for an artificial intelligence device that provides notification about an external situation to a user who is listening sounds through a headset or an earphone.

### SUMMARY OF THE INVENTION

An object of the present disclosure is to solve the problems described above and other problems.

An object of the present disclosure is to provide an artificial intelligence device that provides notification about an external situation to a user who is listening sounds through a headset or an earphone.

An object of the present disclosure is to provide an artificial intelligence device that can acquire and learn correction data for sound instructions that are difficult to recognize, and can perform sound recognition when specific sounds are generated outside in a situation in which it is difficult to hear external sounds.

An embodiment of the present disclosure provides an artificial intelligence device for providing notification to a user using audio data, the artificial intelligence device including: a memory configured to store a trigger sound that should be notified to a user and information about notification corresponding to the trigger sound; a microphone configured to receive audio data; a processor configured to change a volume gain of the microphone on the basis of a noise level of the audio data received from the microphone, to determine whether the audio data received from the microphone correspond to a trigger sound that should be notified to the user, and to extract notification corresponding to the determined trigger sound; and an output unit configured to output the extracted notification.

Further, an embodiment of the present disclosure provides a method of providing notification to a user using audio data, the method including: storing a trigger sound that should be notified to a user and information about notification corresponding to the trigger sound; receiving audio data; changing a volume gain of the microphone on the basis of a noise level of the received audio data; determining whether the audio data received from the microphone correspond to a trigger sound that should be notified to the user; extracting notification corresponding to the determined trigger sound; and outputting the extracted notification.

According to an embodiment of the present disclosure, it is possible to provide notification when somebody calls a user from the outside while the user listens music using a headset.

Further, according to an embodiment of the present disclosure, notification is provided when a specific sound is generated outside even when a user uses a headphone, thereby being able to hear an external sound.

Further, according to an embodiment of the present disclosure, even if a user listens music through an earphone, he/she can be provided with notification about danger when a specific situation occurs outside, thereby being able to prevent an accident.

### BRIEF DESCRIPTION OF THE DRAWINGS

FIG. 1 illustrates an AI device 100 according to an embodiment of the present disclosure.

FIG. 2 illustrates an AI server 200 according to an embodiment of the present disclosure.

FIG. 3 illustrates an AI system 1 according to an embodiment of the present disclosure.

FIG. 4 is a block diagram illustrating an artificial intelligence device according to the present disclosure.

FIG. 5 is a diagram illustrating a speech system according to an embodiment of the present disclosure.

FIG. 6 is a diagram illustrating a process of extracting utterance features of a user from a speech signal according to an embodiment of the present disclosure.

FIG. 7 is a diagram illustrating an example of converting a speech signal into a power spectrum according to an embodiment of the present disclosure.

FIG. 8 is an operation flowchart showing a method of providing notification to a user using audio data.

FIG. 9 is an operation flowchart showing a method of changing a volume gain of a microphone in accordance with a noise level of audio data.

FIGS. 10 to 12 are diagrams illustrating processes of a method in which an artificial intelligence device provides notification in accordance with an embodiment of the present disclosure.

### DETAILED DESCRIPTION OF THE INVENTION

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

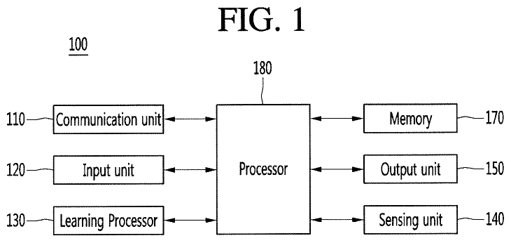

FIG. 1 illustrates an AI device 100 according to an embodiment of the present disclosure.

The AI device (or an AI apparatus) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™ RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

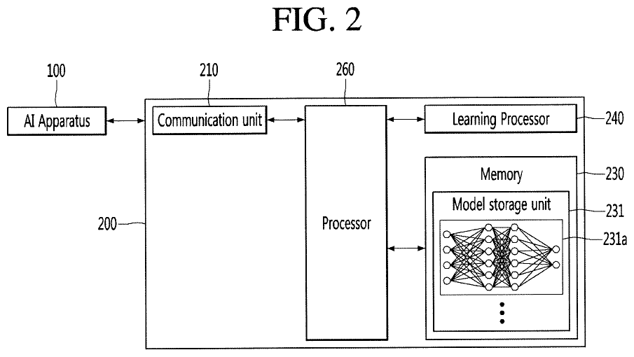

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

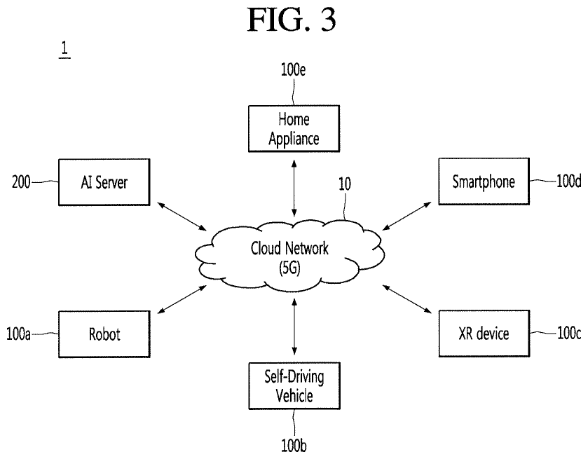

FIG. 3 illustrates an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

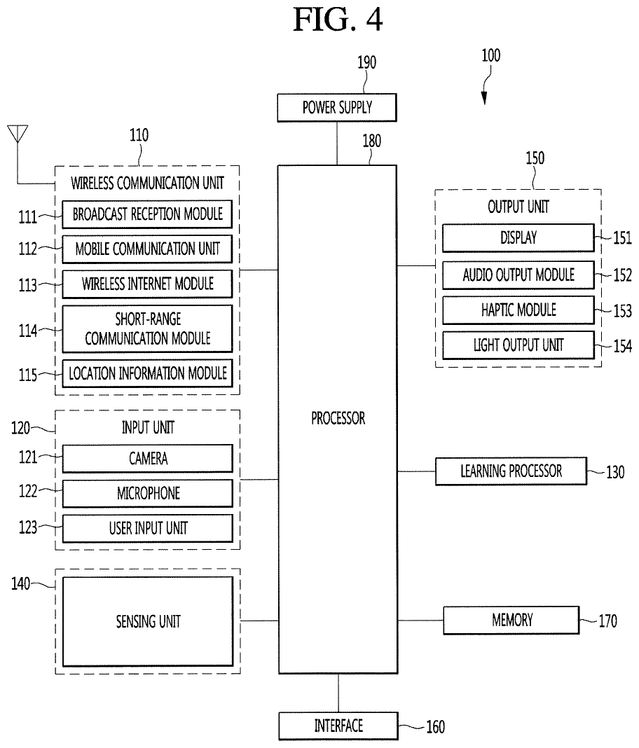

FIG. 4 is a block diagram illustrating an artificial intelligence device according to the present disclosure.

A description overlapping FIG. 1 will be omitted.

The wireless communication unit 110 may include at least one of a broadcast reception module 111, a mobile communication module 112, a wireless Internet module 113, a short-range communication module 114 and a location information module 115.

The broadcast reception module 111 receives broadcast signals and/or broadcast associated information from an external broadcast management server through a broadcast channel.

The mobile communication module 112 may transmit and/or receive wireless signals to and from at least one of a base station, an external terminal, a server, and the like over a mobile communication network established according to technical standards or communication methods for mobile communication (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

The wireless Internet module 113 is configured to facilitate wireless Internet access. This module may be installed inside or outside the artificial intelligence device 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like.

The short-range communication module 114 is configured to facilitate short-range communication and to support short-range communication using at least one of Bluetooth™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The location information module 115 is generally configured to acquire the position (or the current position) of the mobile artificial intelligence device. Representative examples thereof include a Global Position System (GPS) module or a Wi-Fi module. As one example, when the artificial intelligence device uses a GPS module, the position of the mobile artificial intelligence device may be acquired using a signal sent from a GPS satellite.

The input unit 120 may include a camera 121 for receiving a video signal, a microphone 122 for receiving an audio signal, and a user input unit 123 for receiving information from a user.

The camera 121 may process image frames of still images or moving images obtained by image sensors in a video call more or an image capture mode. The processed image frames can be displayed on the display 151 or stored in memory 170.

The microphone 122 processes an external acoustic signal into electrical audio data. The processed audio data may be variously used according to function (application program) executed in the artificial intelligence device 100. Meanwhile, the microphone 122 may include various noise removal algorithms to remove noise generated in the process of receiving the external acoustic signal.

The user input unit 123 receives information from a user. When information is received through the user input unit 123, the processor 180 may control operation of the artificial intelligence device 100 in correspondence with the input information.

The user input unit 123 may include one or more of a mechanical input element (for example, a mechanical key, a button located on a front and/or rear surface or a side surface of the artificial intelligence device 100, a dome switch, a jog wheel, a jog switch, and the like) or a touch input element. As one example, the touch input element may be a virtual key, a soft key or a visual key, which is displayed on a touchscreen through software processing, or a touch key located at a location other than the touchscreen.

The output unit 150 is typically configured to output various types of information, such as audio, video, tactile output, and the like. The output unit 150 may include a display 151, an audio output module 152, a haptic module 153, and a light output unit 154.

The display 151 is generally configured to display (output) information processed in the artificial intelligence device 100. For example, the display 151 may display execution screen information of an application program executed by the artificial intelligence device 100 or user interface (UI) and graphical user interface (GUI) information according to the executed screen information.

The display 151 may have an inter-layered structure or an integrated structure with a touch sensor in order to realize a touchscreen. The touchscreen may provide an output interface between the artificial intelligence device 100 and a user, as well as function as the user input unit 123 which provides an input interface between the artificial intelligence device 100 and the user.

The audio output module 152 is generally configured to output audio data received from the wireless communication unit 110 or stored in the memory 170 in a call signal reception mode, a call mode, a record mode, a speech recognition mode, a broadcast reception mode, and the like.

The audio output module 152 may also include a receiver, a speaker, a buzzer, or the like.

A haptic module 153 can be configured to generate various tactile effects that a user feels. A typical example of a tactile effect generated by the haptic module 153 is vibration.

A light output unit 154 may output a signal for indicating event generation using light of a light source of the artificial intelligence device 100. Examples of events generated in the artificial intelligence device 100 may include message reception, call signal reception, a missed call, an alarm, a schedule notice, email reception, information reception through an application, and the like.

The interface 160 serves as an interface with external devices to be connected with the artificial intelligence device 100. The interface 160 may include wired or wireless headset ports, external power supply ports, wired or wireless data ports, memory card ports, ports for connecting a device having an identification module, audio input/output (I/O) ports, video I/O ports, earphone ports, or the like. The artificial intelligence device 100 may perform appropriate control related to the connected external device in correspondence with connection of the external device to the interface 160.

The identification module may be a chip that stores a variety of information for granting use authority of the artificial intelligence device 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the artificial intelligence device 100 via the interface 160.

The power supply 190 receives external power or internal power and supplies the appropriate power required to operate respective components included in the artificial intelligence device 100, under control of the controller 180. The power supply 190 may include a battery, and the battery may be a built-in or rechargeable battery.

Meanwhile, as described above, the processor 180 controls operation related to the application program and overall operation of the artificial intelligence device 100. For example, the processor 180 may execute or release a lock function for limiting input of a control command of the user to applications when the state of the mobile artificial intelligence device satisfies a set condition.

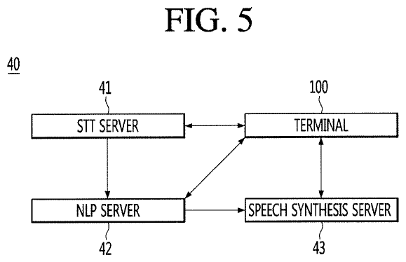

FIG. 5 is a diagram illustrating a speech system according to an embodiment of the present disclosure.

Referring to FIG. 5, the speech system 40 includes an artificial intelligence device 100, a speech-to-text (STT) server 41, a natural language processing (NLP) server 42 and a speech synthesis server 43.

The artificial intelligence device 100 may transmit speech data to the STT server 41.

The STT server 41 may convert the speech data received from the artificial intelligence device 100 into text data.

The STT server 41 may increase accuracy of speech-text conversion using a language model.

The language model may mean a model capable of calculating a probability of a sentence or a probability of outputting a next word is output when previous words are given.

For example, the language model may include probabilistic language models such as a unigram model, a bigram model, an N-gram model, etc.

The unigram model refers to a model that assumes that use of all words is completely independent of each other and calculates the probability of a word string by a product of the probabilities of words.

The bigram model refers to a model that assumes that use of words depends on only one previous word.

The N-gram model refers to a model that assumes that use of words depends on (n−1) previous words.

That is, the STT server 41 may determine when the speech data is appropriately converted into the text data using the language model, thereby increasing accuracy of conversion into the text data.

The NLP server 42 may receive the text data from the STT server 41. The NLP server 42 may analyze the intention of the text data based on the received text data.

The NLP server 42 may transmit intention analysis information indicating the result of performing intention analysis to the artificial intelligence device 100.

The NLP server 42 may sequentially perform a morpheme analysis step, a syntax analysis step, a speech-act analysis step, a dialog processing step with respect to text data, thereby generating intention analysis information.

The morpheme analysis step refers to a step of classifying the text data corresponding to the speech uttered by the user into morphemes as a smallest unit having a meaning and determining the part of speech of each of the classified morphemes.

The syntax analysis step refers to a step of classifying the text data into a noun phrase, a verb phrase, an adjective phrase, etc. using the result of the morpheme analysis step and determines a relation between the classified phrases.

Through the syntax analysis step, the subject, object and modifier of the speech uttered by the user may be determined.

The speech-act analysis step refers to a step of analyzing the intention of the speech uttered by the user using the result of the syntax analysis step. Specifically, the speech-act step refers to a step of determining the intention of a sentence such as whether the user asks a question, makes a request, or expresses simple emotion.

The dialog processing step refers to a step of determining whether to answer the user's utterance, respond to the user's utterance or question about more information.

The NLP server 42 may generate intention analysis information including at least one of the answer to, a response to, or a question about more information on the intention of the user's utterance, after the dialog processing step.

Meanwhile, the NLP server 42 may receive the text data from the artificial intelligence device 100. For example, when the artificial intelligence device 100 supports the speech-to-text conversion function, the artificial intelligence device 100 may convert the speech data into the text data and transmit the converted text data to the NLP server 42.

The speech synthesis server 43 may synthesize prestored speech data to generate a synthesized speech.

The speech synthesis server 43 may record the speech of the user selected as a model and divide the recorded speech into syllables or words. The speech synthesis server 43 may store the divided speech in an internal or external database in syllable or word units.

The speech synthesis server 43 may retrieve syllables or words corresponding to the given text data from the database and synthesize the retrieved syllables or words, thereby generating the synthesized speech.

The speech synthesis server 43 may store a plurality of speech language groups respectively corresponding to a plurality of languages.

For example, the speech synthesis server 43 may include a first speech language group recorded in Korean and a second speech language group recorded in English.

The speech synthesis server 43 may translate text data of a first language into text of a second language and generate a synthesized speech corresponding to the translated text of the second language using the second speech language group.

The speech synthesis server 43 may transmit the synthesized speech to the artificial intelligence device 100.

The speech synthesis server 43 may receive the intention analysis information from the NLP server 42.

The speech synthesis server 43 may generate the synthesized speech including the intention of the user based on the intention analysis information.

In one embodiment, the STT server 41, the NLP server 42 and the speech synthesis server 43 may be implemented as one server.

The respective functions of the STT server 41, the NLP server 42 and the speech synthesis server 43 may also be performed in the artificial intelligence device 100. To this end, the artificial intelligence device 100 may include a plurality of processors.

Further, the function of each of the STT server 41, the NLP server 42, and the speech synthesis server 43 described above may be performed in the artificial intelligence server 200. To this end, the artificial intelligence device 200 may include a plurality of processors.

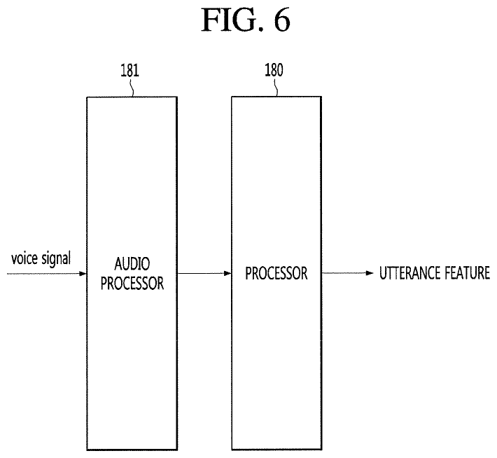

FIG. 6 is a diagram illustrating a process of extracting utterance features of a user from a speech signal according to an embodiment of the present disclosure.

The artificial intelligence device 100 shown in FIG. 1 may further include an audio processor 181.

The audio processor 181 may be implemented as a chip separated from the processor 180 or a chip included in the processor 180.

The audio processor 181 may remove noise from the speech signal.

The audio processor 181 may convert the speech signal into text data. To this end, the audio processor 181 may include an STT engine.

The audio processor 181 may recognize a wake-up word for activating speech recognition of the artificial intelligence device 100. The audio processor 181 may convert the wake-up word received through the microphone 121 into text data and determine that the wake-up word is recognized when the converted text data corresponds to the prestored wake-up word.

The audio processor 181 may convert the speech signal, from which noise is removed, into a power spectrum.

The power spectrum may be a parameter indicating a frequency component included in the waveform of the speech signal varying with time, and a magnitude thereof.

The power spectrum shows a distribution of an amplitude squared value according to the frequency of the waveform of the speech signal.

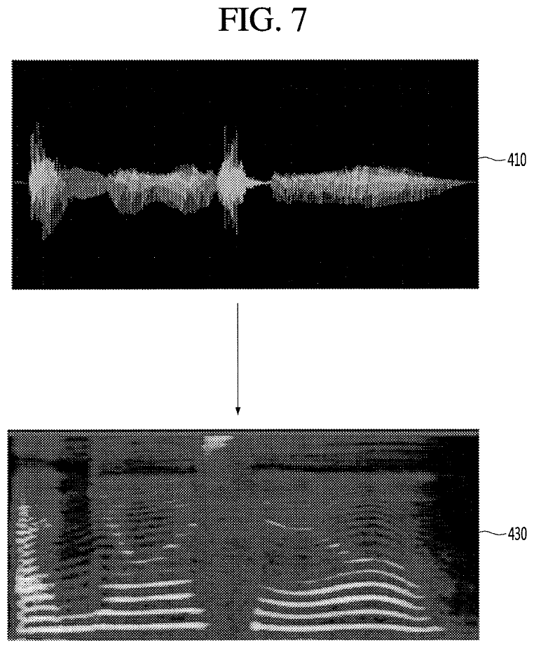

This will be described with reference to FIG. 7.

FIG. 7 is a diagram illustrating an example of converting a speech signal into a power spectrum according to an embodiment of the present disclosure.

Referring to FIG. 7, the speech signal 410 is shown. The speech signal 410 may be received through the microphone 121 or prestored in the memory 170.

The x-axis of the speech signal 410 denotes a time and the y-axis denotes an amplitude.

The audio processor 181 may convert the speech signal 410, the x-axis of which is a time axis, into a power spectrum 430, the x-axis of which is a frequency axis.

The audio processor 181 may convert the speech signal 410 into the power spectrum 430 using Fast Fourier transform (FFT).

The x-axis of the power spectrum 430 denotes a frequency and the y-axis of the power spectrum 430 denotes a squared value of an amplitude.

FIG. 6 will be described again.

The processor 180 may determine utterance features of a user using at least one of the power spectrum 430 or the text data received from the audio processor 181.

The utterance features of the user may include the gender of the user, the pitch of the user, the tone of the user, the topic uttered by the user, the utterance speed of the user, the volume of the user's voice, etc.

The processor 180 may acquire the frequency of the speech signal 410 and the amplitude corresponding to the frequency using the power spectrum 430.

The processor 180 may determine the gender of the user who utters a speech, using the frequency band of the power spectrum 430.

For example, the processor 180 may determine the gender of the user as a male when the frequency band of the power spectrum 430 is within a predetermined first frequency band range.

The processor 180 may determine the gender of the user as a female when the frequency band of the power spectrum 430 is within a predetermined second frequency band range. Here, the second frequency band range may be larger than the first frequency band range.

The processor 180 may determine the pitch of the speech using the frequency band of the power spectrum 430.

For example, the processor 180 may determine the pitch of the speech according to the amplitude within a specific frequency band range.

The processor 180 may determine the tone of the user using the frequency band of the power spectrum 430. For example, the processor 180 may determine a frequency band having a certain amplitude or more among the frequency bands of the power spectrum 430 as a main register of the user and determines the determined main register as the tone of the user.

The processor 180 may determine the utterance speed of the user through the number of syllables uttered per unit time from the converted text data.

The processor 180 may determine the topic uttered by the user using a Bag-Of-Word Model scheme with respect to the converted text data.

The Bag-Of-Word Model scheme refers to a scheme for extracting mainly used words based on the frequency of words in a sentence. Specifically, the Bag-Of-Word Model scheme refers to a scheme for extracting unique words from a sentence, expressing the frequency of the extracted words by a vector and determining the uttered topic as a feature.

For example, when words <running>, <physical strength>, etc. frequently appears in the text data, the processor 180 may classify the topic uttered by the user into an exercise.

The processor 180 may determine the topic uttered by the user from the text data using a known text categorization scheme. The processor 180 may extract keywords from the text data and determine the topic uttered by the user.

The processor 180 may determine the volume of user's voice in consideration of the amplitude information in an entire frequency band.

For example, the processor 180 may determine the volume of user's voice based on an average or weighted average of amplitudes in each frequency band of the power spectrum.

The functions of the audio processor 181 and the processor 180 described with reference to FIGS. 6 and 7 may be performed in any one of the NLP server 42 or the speech synthesis server 43.

For example, the NLP server 42 may extract the power spectrum using the speech signal and determine the utterance features of the user using the extracted power spectrum.

The speech synthesis server 43, which is a device or a server separately provided outside the terminal 100, can perform the same function as the learning processor 130 of the terminal 100.

The speech synthesis server 43, which is a device or a server separately provided outside the terminal 100, can perform the same function as the learning processor 130 of the terminal 100.

That is, the function of the speech synthesis server 43 can be performed in the same way even by the learning processor 130 of the terminal 100.

The speech synthesis server 43 can communicate with at least one terminal 100 and can derive a result by analyzing or learning data instead of or by helping the terminal 100. The meaning of helping another device may mean distribution of a calculation ability through a distribution process. Accordingly, the learning processor 130 of the terminal 100 can derive a result by analyzing or learning data with help of the speech synthesis server 43.

The speech synthesis server 43, which may be various devices for learning an artificial neural network, generally, may mean a server and may be referred to as a learning device or a learning server.

In particular, the speech synthesis server 43 may be implemented as not only a single server, but also a set of a plurality of servers, a cloud server, or a combination thereof.

That is, the speech synthesis server 43 may be provided as a plurality of pieces to configure a learning device set (or a cloud server), and at least one speech synthesis server 43 included in the learning device set can derive a result by analyzing or learning data through a distribution process.

The speech synthesis server 43 can transmit a model learned through machine learning or deep learning to the terminal 100 periodically or in response to a request.

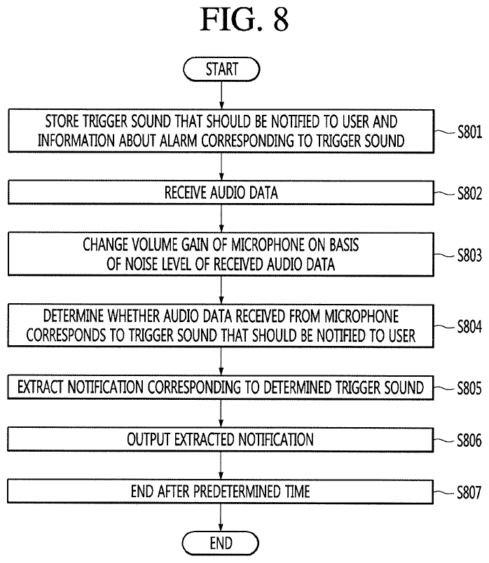

FIG. 8 is an operation flowchart showing a method of providing notification to a user using audio data.

The memory 170 can store a trigger sound that should be notified to a user and information about notification corresponding to the trigger sound (S801).

Here, the trigger sound that should be notified to a user may the user's name, a specific word, a specific sentence, and a specific sound. For example, a user wearing a headset may not hear sounds generated outside. Accordingly, when the user's name is called outside, notification saying that the user's name has been called should be provided to the user. In this case, the user's name may be a trigger sound that should be notified to the user.

Further, the information about notification corresponding to the trigger sound is information about what notification should be provided to the user, depending on each trigger sound. For example, when the trigger sound is the user's name, the notification corresponding to the trigger sound may be an announcement such as ‘The name of the user has been called from the outside’ or an alarm such as ‘beep’ or ‘beep beep’. Alternatively, it may be possible to provide an external sound itself that is received through a microphone as notification.

The processor 180 may receive a trigger sound and information about notification corresponding to the trigger sound from a user through the user input unit 123 and store the input trigger sound and information about notification corresponding to the trigger sound in memory 170. Accordingly, the user of the artificial intelligence device 100 can set trigger sounds for which he/she wants to receive notification and can set notification corresponding to the trigger sounds.

Further, the processor 180 can receive a trigger sound and information about notification corresponding to the trigger sound through the communication unit 110. For example, when a user inputs a trigger sound and information about notification corresponding to the trigger sound through an external device, the processor 180 can receive the trigger sound and the information about notification corresponding to the trigger sound from the external device through the communication unit 110.

The microphone 122 can receive audio data (S802).

The microphone 122 can receive audio data by processing an audio signal from the outside into electrical audio data.

The artificial intelligence device 100 may include at least one or more microphones 122.

When a plurality of microphones 122 is provided, the processor 180 can determine a sound source direction of audio data from audio data received from each of the plurality of microphones 122.

For example, the processor 180 can determine the sound source direction of audio data in accordance with the volume of audio data received from each of the plurality of microphones 122.

Further, when outputting notification corresponding to a trigger sound, the processor 180 can output the determined sound source direction through the output unit 150.

For example, the processor 180 can output visual information about the determined sound source direction through the display unit 151. Further, when outputting notification through the audio output module 152, the processor 180 can output aural information by increasing the volume of the determined sound source direction larger than the volume of the other directions. Further, the processor 180 can output vibration in the sound source direction through the haptic module 153. For example, when the artificial intelligence device 100 is a headset and the left is the sound source direction, the processor 180 can output vibration to the left side of the headset through the haptic module 153.

The processor 180 can change the volume gain of the microphone 122 on the basis of the noise level of audio data received from the microphone 122.

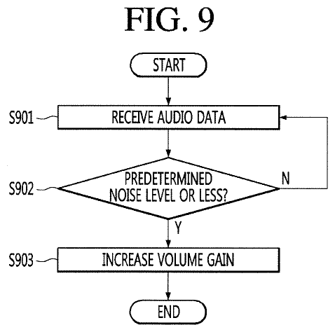

Referring to FIG. 9, the microphone 122 can receive audio data (S901). Further, the processor 180 can determine whether the noise level of audio data received from the microphone 122 is a predetermined noise level or less (S902). Further, the processor 180 can increase a volume gain when the noise level of the audio data received from the microphone 122 is the predetermined noise level or less (S903).

For example, when the noise level of audio data received from the microphone 122 is 50 dB or less, the volume gain of the microphone 122 is increased so that the microphone 122 can remove more external audio data.

Meanwhile, the processor 180 can change the volume gain to the predetermined volume gain when the noise level of the audio data received from the microphone 122 exceeds the predetermined noise level. For example, when the noise level of audio data received from the microphone 122 exceeds 50 dB, it is possible to change the volume gain of the microphone 122 to a basic volume gain value.

The processor 180 can determine whether audio data received from the microphone 122 correspond to a trigger sound for which notification should be provided to a user (S804).

The processor 180 can determine whether audio data correspond to a trigger sound on the basis of similarity by comparing audio data received from the microphone 122 and trigger sounds stored in the memory 170.

Further, the processor 180 can acquire text data by providing audio data received from the microphone 122 to a voice recognition model. The processor 180 can determine whether the audio data correspond to a trigger sound on the basis of the text data.

Here, the sound recognition model, which is at least one of an STT (Speech to Text) engine for converting voice input into a character string or an NLP (Natural Language Processing) engine for acquiring intention information of natural language, may be configured as an artificial neural network learned in accordance with a machine learning algorithm.

For example, when somebody calls the name “HONG, Gil Dong” of a user from the outside, the processor 180 can acquire text data “HONG, Gil Dong” by providing the audio data received from the microphone 122 to a voice recognition model. The processor 108 can determine whether the audio data correspond to a trigger sound by searching the memory 170 to check whether the trigger sound corresponding to “HONG, Gil Dong” that is text data has been stored therein.

Further, the processor 180 can acquire intention analysis information about the text data and can determine whether the audio data correspond to a trigger sound on the basis of the intention analysis information.

For example, the processor 180 can acquire intention analysis information using an NLP (Natural Language Processing) engine configured as an artificial neural network learned in accordance with a machine learning algorithm.

For example, when a warning sound “Watch it” is generated from the outside, the processor 180 can acquire text data “Watch it” by providing the audio data received from the microphone 122 to a voice recognition model. Further, the processor 108 can acquire intention analysis information about “Watch it” that is the acquired text data and can determine whether the audio data correspond to a trigger sound by searching the memory 170 to check whether the trigger sound having the same intention analysis information has been stored therein.

Further, the processor 180 can acquire situation information by providing the audio data to a situation recognition model and can determine whether the audio data correspond to a trigger sound on the basis of the situation information.

The situation recognition model may be a neural network learned by labeling situation information about each of non-voice data. For example, the situation recognition model may be a neural network learned by labeling situation information showing a dangerous situation to each of learning sound data such as a siren or a horn.

For example, when audio data is a siren, the processor 180 can acquire situation information ‘dangerous situation’ by providing audio data to a situation recognition model, and can determine whether the audio data correspond to a trigger sound by searching the memory 170 to check whether a trigger sound having the same situation information has been stored therein.

The processor 180 can extract notification corresponding to the determined trigger sound (805).

Notification corresponding to a trigger sound is notification for informing a user of an external situation.

For example, when the user's name is a trigger sound, the corresponding notification may be a voice notification message “Name has been called”, a beeping sound “beep beep”, or the audio data itself received through the microphone 122.

The output unit 150 can output the extracted notification (S806).

The output unit 150 can output aural information about the extracted notification. For example, the output unit 150 can output a voice notification message “Name has been called” through the audio output module 152 or can output a beeping sound “beep beep” through the audio output module 152.

The output unit 150 can output audio data received from the microphone 122. For example, the output unit 150 can output audio data received from the microphone 122 through the audio output module 152 using loopback.

The output unit 150 can output visual information about the extracted notification through the display unit 151. Further, the output unit 150 can output vibration for the extracted notification through the haptic module 153. Further, the output unit 150 can output light for the extracted notification through the optical output unit 154.

The output unit 150 can repeatedly output the extracted notification with a predetermined period.

When a predetermined time passes after the extracted notification is output through the output unit 150, the processor 180 can control the output unit 150 to stop outputting the extracted notification. Accordingly, it is possible to prevent a user from keeping receiving unnecessary notification.

Further, the sensing unit 140 can acquire information about whether a user wears the artificial intelligence device 100. For example, the sensing unit 140 can acquire information about the distance between the artificial intelligence device 100 and another object through a proximity sensor.

The processor 180 can determine whether a user wears the artificial intelligence device 100 on the basis of the distance between the artificial intelligence device 100 and another object measured through the sensing unit 140.

For example, when the distance between the artificial intelligence device 100 and another object measured through the sensing unit 140 is a predetermined distance or less, the processor 180 can determine that the user wears the artificial intelligence device 100.

Further, when the distance between the artificial intelligence device 100 and another object measured through the sensing unit 140 exceeds the predetermined distance, the processor 180 can determine that the user does not wear the artificial intelligence device 100 on his/her body.

When determining that the user does not wear the artificial intelligence device 100, the processor 180 can control the output unit 150 to stop outputting the extracted notification.

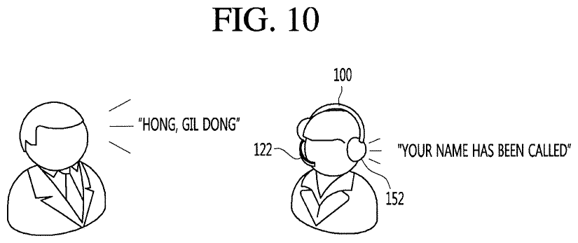

FIGS. 10 to 12 are diagrams illustrating processes of a method in which an artificial intelligence device provides notification in accordance with an embodiment of the present disclosure.

Referring to FIG. 10, a user wears the artificial intelligence device 100 and the user's name is being called from the outside.

The user's name “HONG, Gil Dong” is stored in the memory 170 of the artificial intelligence device 100 as a trigger sound that should be notified to the user. Further, an announcement message “Your name has been called” that is notification corresponding to the trigger sound “HONG, Gil Dong” is stored in the memory 170 of the artificial intelligence device 100. The microphone 122 can receive audio data “HONG, Gil Dong” generated outside.

The processor 180 can acquire text data “HONG, Gil Dong” by providing the audio data “HONG, Gil Dong” to a voice recognition model.

The processor 180 can determine whether the audio data “HONG, Gil Dong” generated outside correspond to a trigger sound on the basis of the text data.

The processor 180 can search the memory 170 to check whether a trigger sound corresponding to the text data “HONG, Gil Dong” is stored therein.

The processor 180 determines that the audio data “HONG, Gil Dong” generated outside corresponds to a trigger sound “HONG, Gil Dong”, and can output notification, that is, an announcement message “Your name has been called” corresponding to the trigger sound.

The processor 180 can output the announcement message “Your name has been called” through the audio output module 152. Accordingly, the user can recognize that his/her name has been called from the outside even though he/she wears a headset.

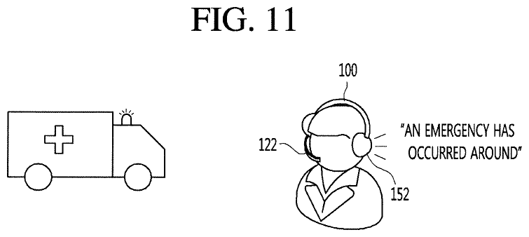

Referring to FIG. 11, a user wears the artificial intelligence device 100 and an ambulance is passing by while blowing a siren.

A siren sound is stored in the memory 170 of the artificial intelligence device 100 as a trigger sound that should be notified to the user.

For the siren sound that is stored in a trigger sound, actual siren sound data may be stored in a trigger sound. In this case, the processor 180 can determine whether audio data corresponds to a trigger sound on the basis of similarity between audio data received through the microphone 122 and actual siren sound data.

Meanwhile, a trigger sound having situation information that is ‘emergency’ may be stored in the memory 170 of the artificial intelligence device 100.

For example, the processor 180 can acquire situation information that is an ‘emergency’ by providing a siren sound that is audio data received through the microphone 122 to a situation recognition model. Further, the processor 180 can search the memory 170 to check whether a trigger sound having situation information that is an ‘emergency’ is stored in the memory 170.

The processor 180 determines that the audio data “siren sound” generated outside corresponds to a trigger sound, and can output notification, that is, an announcement message “An emergency has occurred around” corresponding to the trigger sound.

The processor 180 can output the announcement message “An emergency has occurred around” through the audio output module 152. Accordingly, the user can recognize that an emergency has occurred outside even though he/she wears a headset.

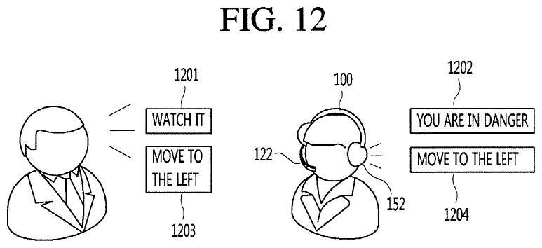

Referring to FIG. 12, a user wears the artificial intelligence device 100 and danger is notified from the outside.

The processor 180 can acquire text data “Watch it” by providing first audio data “Watch it” received from the microphone 122 to a voice recognition model.

The processor 180 can acquire intention analysis information about “Watch it” that is the acquired text data, using an NLP (Natural Language Processing) engine.

The processor 108 can determine whether the first audio data correspond to a trigger sound by searching the memory 170 to check whether a trigger sound having the same intention analysis information is stored therein.

The processor 180 can extract a voice message “You are in danger” that is notification corresponding to the determined trigger sound. The audio output module 154 can output a voice message “You are in danger” that is the extracted notification.

Further, the output unit 150 can output second audio data “Move to the left” 1203 received from the microphone 122. For example, the output unit 150 can output “Move to the left” 1204, which is the second audio data 1230 received from the microphone 122, through the audio output module 152 using loopback. Accordingly, the user can recognize the external dangerous situation, even wearing a headset, and can immediately hear an external sound even without taking off the headset.

The present disclosure can be achieved as computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage. Further, the computer may include the processor 180 of a terminal.

What is claimed is:

1. An artificial intelligence device for providing a notification to a user using audio data, the artificial intelligence device comprising:
a memory configured to store a trigger sound for notifying a user and information about a notification corresponding to the trigger sound;
at least one microphone configured to receive audio data;
a processor configured to:
change a volume gain of the microphone based on a noise level of the audio data received from the at least one microphone, and
in response to the audio data received from the at least one microphone corresponding to the trigger sound, extract the notification corresponding to the trigger sound; and
an outputter configured to output the notification.

2. The artificial intelligence device of claim 1, wherein the processor is further configured to:
in response to the noise level of the audio data received from the at least one microphone being less than or equal to a predetermined noise level, increase the volume gain of the microphone.

3. The artificial intelligence device of claim 1, wherein the outputter outputs the audio data received from the microphone and the notification together.

4. The artificial intelligence device of claim 1, wherein the at least one microphone includes a plurality of microphones and the processor determines a sound source direction of an audio source from audio data received from each of the plurality of microphones, and
wherein the outputter outputs information regarding the sound source direction when outputting the notification.

5. The artificial intelligence device of claim 1, wherein the processor is further configured to:
control the outputter to stop outputting the notification when a predetermined amount of time passes after the notification starts to be output through the outputter.

6. The artificial intelligence device of claim 1, wherein the processor is further configured to:
provide the audio data to a voice recognition model for generating text data based on the audio data, and
determine whether the audio data corresponds to the trigger sound based on the text data.

7. The artificial intelligence device 6, wherein the processor is further configured to:
acquire intention analysis information about the text data, and
determine whether the audio data corresponds to the trigger sound based on the intention analysis information.

8. The artificial intelligence device of claim 1, wherein the processor is further configured to:
provide the audio data to a situation recognition model for generating situation information, and
determine whether the audio data corresponds to the trigger sound based on the situation information.

9. The artificial intelligence device of claim 1, wherein the trigger sound includes at least one of a name of the user, a beep sound, a voice command, or a siren sound.

10. The artificial intelligence device of claim 1, wherein the audio data corresponding to the trigger sound is received while the outputter is outputting music.

11. A method of providing a notification to a user using audio data, the method comprising:
storing a trigger sound for notifying a user and information about a notification corresponding to the trigger sound;
receiving audio data from at least one microphone;
changing a volume gain of the at least one microphone based on a noise level of the audio data; and
in response to the audio data corresponding to the trigger sound, outputting the notification corresponding to the trigger sound.

12. The method of claim 11, wherein the changing of the volume gain includes increasing the volume gain of the at least one microphone when the noise level of the audio data received from the at least one microphone is less than or equal to a predetermined noise level.

13. The method of claim 11, wherein the outputting includes outputting the audio data received from the at least one microphone.

14. The method of claim 11, wherein the at least one microphone includes a plurality of microphones,
wherein the receiving of the audio data includes determining a sound source direction of an audio source from audio data received from each of the plurality of microphones, and
wherein the outputting includes outputting information regarding the sound source direction.

15. The method of claim 11, further comprising:
stopping the outputting of the notification when a predetermined amount of time passes after the notification starts to be output.

16. The method of claim 11, further comprising:
providing the audio data to a voice recognition model for generating text data based on the audio data; and
determining whether the audio data corresponds to the trigger sound based on the text data.

17. The method of claim 16, further comprising:
acquiring intention analysis information about the text data; and
determining whether the audio data corresponds to the trigger sound based on the intention analysis information.

18. The method of claim 11, further comprising:
in response to the audio data corresponding to the trigger sound and the audio data not including a voice, providing the audio data to a situation recognition model for generating situation information; and
determining whether the audio data corresponds to the trigger sound based on the situation information.

19. A device for providing a notification to a user based on artificial intelligence, the device comprising:
a memory configured to store a trigger sound for notifying a user;
at least microphone configured to receive audio data;
at least one speaker configured to output audio content; and
a controller configured to:
receive the audio data from the at least one microphone corresponding to the trigger sound while the at least one speaker is outputting the audio content, and
output an audio notification via the at least one speaker based on the trigger sound received by the at least microphone and learning data corresponding to one or more trigger sounds.

20. The device of claim 19, wherein the trigger sound corresponds to a name of the user of the device.
